(19) United States
(12) Patent Application Publication
(10) Pub. No.: US 2013/0218771 A1
(43) Pub. Date: Aug. 22, 2013

(54) ELECTRONIC PAYMENT UNIT, ELECTRONIC PAYMENT ORIGIN AUTHENTICATION SYSTEM AND METHOD

(71) Applicant: Michael Jarman, Ellesmere Port (GB)

(72) Inventor: Michael Jarman, Ellesmere Port (GB)

(73) Assignee: SECURE ELECTRANS LIMITED, London, Greater London (GB)

(21) Appl. No.: 13/699,513

(22) PCT Filed: May 24, 2011
(86) PCT No.: PCT/GB2011/050974

§ 371 Date: May 1, 2013

(30) Foreign Application Priority Data
May 24, 2010 (GB) 1008567.8
Feb. 2, 2011 (GB) 1101789.4

(51) Int. Cl. G06Q 20/34

(52) U.S. Cl. CPC G06Q 20/34
USPC 705/44

(57) ABSTRACT

An electronic payment unit including includes a data communications interface, a payment card reader and a memory. During a registration process between the electronic payment unit and a registering system at a location having a unique identifier associated with the location, the electronic payment unit is operative to store the unique identifier, or data derived from or including the unique identifier in the memory. The payment card reader is arranged to read a payment card during an electronic transaction, and to form for transmission, via the data communications interface, an electronic payment request including data on the payment card and on the content of the memory. An associated system and method are also disclosed.

### FIELD OF THE INVENTION

The present invention relates to an electronic payment unit, electronic payment system and method that are particularly suitable for authentication of the origin of a data communication.

### BACKGROUND TO THE INVENTION

Data communications are becoming ubiquitous. They feature in most aspects of life and are becoming fundamental to households, businesses, personal lives, banking, shopping and communications. The increasing trend of interconnectivity and monitoring of systems and devices means that data communications will become more and more central to our daily lives for even the most mundane tasks.

It has become widely accepted to conduct transactions such as financial transactions electronically. Fraud is always an issue in financial transactions. The highest percentages of fraudulent transactions occur where the purchaser is not physically present when making the transaction. For example, a much higher percentage of orders made over the telephone and over the internet are fraudulent compared to those made at a point of sale in a shop etc.

Credit and debit cards remain the payment type of choice for electronic transactions made over the internet or by telephone. It is highly unusual for a merchant not to accept such payment mechanisms and the majority of the adult population have at least one credit and/or debit card.

Transactions where the credit or debit card is not physically present to be verified by the merchant are referred to as “card not present” transactions in the financial payment industry. In making a card not present order, a purchaser discloses his or her name, credit card number and expiry date in order for the credit card to be charged for a product or service. The card itself is not present at the point of sale so it cannot be checked.

These sorts of transactions are different to so-called “card present” transactions at Electronic Point-of-Sale Terminals or the like, where both the cardholder (purchaser) and the card are required to be physically present. The purchaser is required to sign an authorisation or enter a pin number to permit a transaction to be charged against that card's account. The merchant is accountable for the verification and authentication of the card and the validation of the cardholder's identity.

By the fact that:

1. A recognisable card is presented

2. Identification, Authorisation and Entitlement processes are enforced

3. The location of the transaction is legitimate

Then the transaction qualifies as a “card present” transaction.

Typically in “card not present” transactions it is not possible to verify the identity of the purchaser and the validity of the “card”. Anybody knowing the information contents of a valid credit card can make purchases and charge that card account with “card not present” transactions. The purchaser need not even have the card. A common fraudulent practice is to acquire discarded credit card receipts, which contain the necessary account information, to create fraudulent “card not present” transactions. In order to avoid this, many receipts now only specify part of the account information. Additionally, some merchants will only deliver to the address registered with the customer's credit card issuer (usually a Financial Institution). Recently, computer programs have been developed and made available on the Internet that successfully generate random credit card numbers. While the numbers generated may not always be valid, computing power is such that a brute force approach can be applied as a 99% or higher failure rate still means that valid numbers are generated. In order to combat this, a relatively crude way of providing some assurance that the card was held by the purchaser at the time of the transaction was introduced. A code (called, among other things, the CVV—card verification value) was added to the physical cards and was not included in transaction receipts etc. Therefore (in theory) the provision of the code in card not present transactions provided an indication that the physical card was in the purchaser's possession.

One particular area where the use of credit cards is increasing exponentially is on the World Wide Web in e-commerce websites and the like. Whilst credit and debit cards are currently the only commonly accepted and feasible ways for such sites to be paid for their products or services, the lack of security in transactions across the Internet, even if encrypted, has resulted in many financial issues and privacy concerns. Because transactions can be intercepted or monitored, unscrupulous persons are obtaining credit card numbers and fraudulently using them for other purchases. The level of security provided by websites varies considerably and many sites have found themselves being attacked for the contents of their databases containing credit card details.

In response to the potential and actual problems, the international bodies responsible for credit cards, including VISA™ and MasterCard™, have introduced premium charges and different terms and conditions for merchants using their services depending on whether the card is present. For example, a merchant submitting a card present transaction may typically be charged 0.75% up to 3% of the transaction value by the financial institution whereas a merchant submitting a card not present transaction may be charged 4 to 5% or more.

An online merchant, who is competing with traditional merchants using point-of-sale “card present” transactions, has to bear a substantial overhead; this reduces his profit margin if he or she wishes to remain competitive. The main reason that the international card issuing bodies claim that the premiums are justified is that a consumer has a legal right to claim against a credit card issuer if the order is not properly fulfilled. Where there is a dispute over a “card not present” transaction, such as the validity of the amount charged, authenticity of the transaction or proven receipt of goods, the rules favour the consumer over the card issuer/merchant. In order to cover themselves against losses and overheads from dealing with these fraudulent transactions, card issuers add a premium to the merchant discount rate, as a form of insurance. As a double blow, the merchant is also accountable for all costs for transactions in dispute.

Clearly a merchant who processes card not present transactions is at a disadvantage. However, it is a desirable business model to operate a virtual/online store or service because this does not entail the same overheads of a bricks and mortar operation.

Various mechanisms have been suggested that allow mobile telephones and the like to act either as a credit card themselves or as a means for authenticating the legitimacy of a transaction. A user presents the device or card (physically or virtually such as presenting a near field chip enabled device or card in proximity to a near field chip reader), the system detects that the device or card has been presented and sends a query to the mobile telephone. Only upon approval from the mobile telephone is the transaction completed and approved. In such systems, changes are required to the back-end processing such that verification is sought during the authentication process. These additional complexities and reliance on communication with yet another device (and the fact that the phone is charged, has a data signal etc.) are issues that merchants, users and financial institutions would like to avoid.

Unfortunately, data communications are very easily spoofed. A recurring problem is that it is relatively straightforward for someone to pretend to be somebody else (or somewhere else) and produce an otherwise genuine looking data communication. Therefore reliance on data entered via a user owned interface is considered unreliable and only offered if nothing else is available. Due to lack of trust, such systems currently have a low limit on transaction value.

One particular issue is the authentication of origin. There are systems that track data communications via network addresses such as IP addresses. However, these can be spoofed and are also unsuitable where a shared IP address is relied upon. Furthermore, the network address is usually provided by the network operator and may therefore be location agnostic. Depending on the manner in which network addresses are allocated, it is possible that a user based in London, UK, may have a network address that is only one increment different from a user having a network address in Durban, South Africa for example.

With the advent of virtual private networks and other tunnelling technologies, it is also possible to obtain a network address that is local to a particular populous whereas in fact the user is operating from a completely different country.

### STATEMENT OF INVENTION

According to an aspect of the present invention, there is provided an electronic payment unit including a data communications interface, a payment card reader and a memory, wherein

during a registration process between the electronic payment unit and a registering system at a location having a unique identifier associated with the location, the electronic payment unit is operative to store the unique identifier, or data derived from or including the unique identifier in the memory;

the payment card reader being arranged to read a payment card during an electronic transaction, and to form for transmission, via the data communications interface, an electronic payment request including data on the payment card and on the content of the memory.

The unit may further comprise a payment card registration module arranged to register a payment card for subsequent use with the electronic payment unit, wherein the payment card reader is arranged to form an electronic payment request only for a registered card.

The payment card registration module may be operable only when the electronic payment unit is in communication with the registering system at the location.

The payment card registration module may be operable only during the registration process.

The data communications interface may comprise a data connector for connecting the electronic payment unit to a computer.

The data connector may comprise a universal serial bus, USB, connector.

The unit may further comprise a further memory encoding a driver executable by a computer connected via the data connector for accessing the electronic payment unit.

The further memory may be segregated from the memory for storing the data derived from or including the unique identifier.

The unit may further comprise a geolocation module, the geolocation module being arranged to provide data on its location, the electronic payment unit being arranged to include a status identifier in an electronic payment request, the status identifier designating geo-location assurance.

The geo-location assurance may include a guaranteed geo-location assurance state in which the unique identifier is cryptographically bound to a location in which the registering system is fixed and, said registering system having been previously verified as being at the location and wherein the electronic payment unit is in substantially real-time communication with the registering system.

The geo-location assurance may include a time lapsed guaranteed geo-location assurance state in which the unique identifier is cryptographically bound to a location in which the registering system is fixed and in which communication between the electronic payment unit communicated with the registering system at the location within a predetermined time frame.

In one embodiment, a portable computing device may include an electronic payment unit as discussed above, the data communications interface comprising a data communications interface of the portable computing device.

The portable computing device may comprise a tablet computing device having a touch screen arranged to receive user inputs, the electronic payment unit being arranged to output a request for approval of the electronic transaction from a user via the touch screen and receive said approval from the user via inputs via the touch screen, the electronic payment request being formed only upon receipt of said approval.

The payment card may have an associated authentication code, wherein said approval includes inputting at least a part of said authentication code or data derived from said code via the touch screen.

According to another aspect of the present invention, there is provided an electronic payment origin authentication system including a registration device fixed at a location and having a unique identifier, the registration device including a processor and a data communication interface, the processor being operable to receive a registration request via the data communication interface from an electronic payment unit at the location and is operable to provide registration data to the electronic payment unit in dependence on the unique identifier, the registration data authenticating that the electronic payment unit was present at the location at the time of registration.

The registration device may comprise a utility meter. The unique identifier may comprise a meter point administration number.

The system may further comprise a database cross-referencing said registration data with data on the respective location.

The registration data may comprise a digital certificate determined in dependence on data held by the registration device.

The digital certificate may be uniquely associated with the electronic payment unit.

The registration data may include a validity period, the registration data being valid only until expiry of said validity period.

The system may include a geolocation system, the geolocation system being arranged to provide geolocation data on the location, the registration data being generated in dependence on the geolocation data. At least one of the registration device and the electronic payment unit may include the geolocation system.

According to another aspect of the present invention, there is provided a method of authenticating origin of an electronic payment comprising:

registering an electronic payment unit with a registering system at a location, the registering system having a unique identifier associated with the location; writing the unique identifier, or data derived from or including the unique identifier to the electronic payment unit;

during an electronic transaction, reading a payment card using the electronic payment unit; and,

forming an electronic payment request including data on the payment card and on the unique identifier.

### DETAILED DESCRIPTION

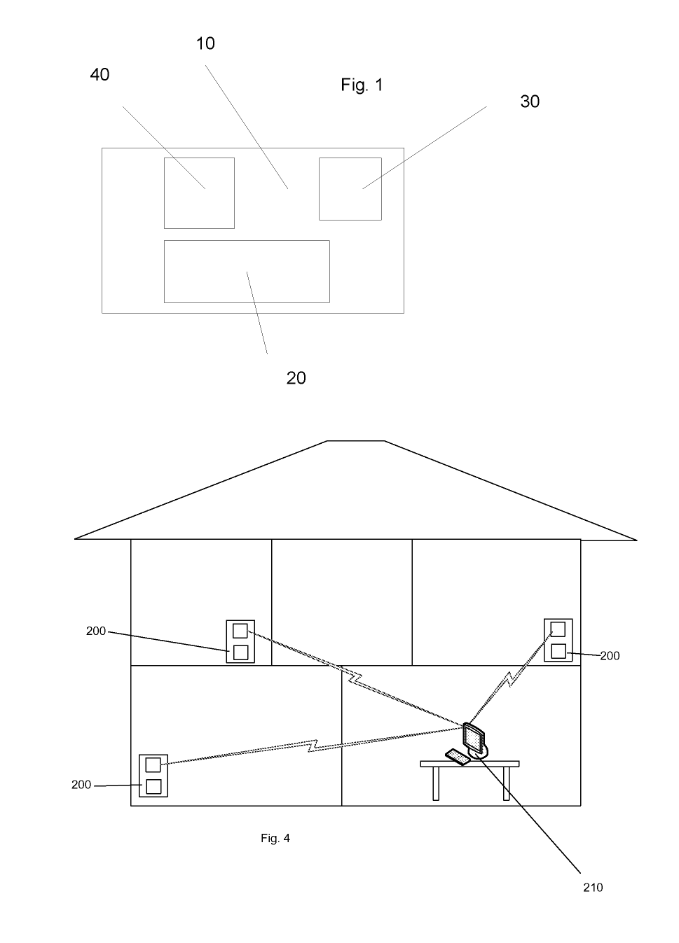

FIG. 1 is a schematic diagram of an electronic payment unit according to an embodiment of the present invention.

The electronic payment unit 10 includes a data communications interface 20, a payment card reader 30 and a memory 40.

The electronic payment unit 10 is registered at a particular pre-registered or predetermined physical location (typically the user's home). A unique identifier associated with the registered location is written or otherwise stored in the memory 40 during registration as is discussed in more detail below.

It will be appreciated that the electronic payment unit or some other external system may perform the writing/recordal/storage of the identifier. It may be that the identifier is provided on a memory card or similar that is inserted into the card reader or other interface of the unit and read by the unit 10.

Upon wishing to make an electronic payment, a user inserts or otherwise presents a payment card (such as a credit or debit card smart card or magnetic stripe card) into the payment card reader 30 and performs any authentication needed by the card via a user interface (discussed in more detail below). Upon authentication, a data communication that includes an electronic payment request is formed and transmitted to a bank, financial clearing house or other party responsible for the payment card or transaction. The data communication includes data on the payment card (including data confirming the card was physically present and authenticated) and also includes data on the unique identifier held by the electronic payment unit 10 in the memory 40.

The communications interface 20 may be mobile telephony, fixed line telephony, or wireless data communications network interface such as IEEE 802.11x, Zigbee, USB, Bluetooth or the like.

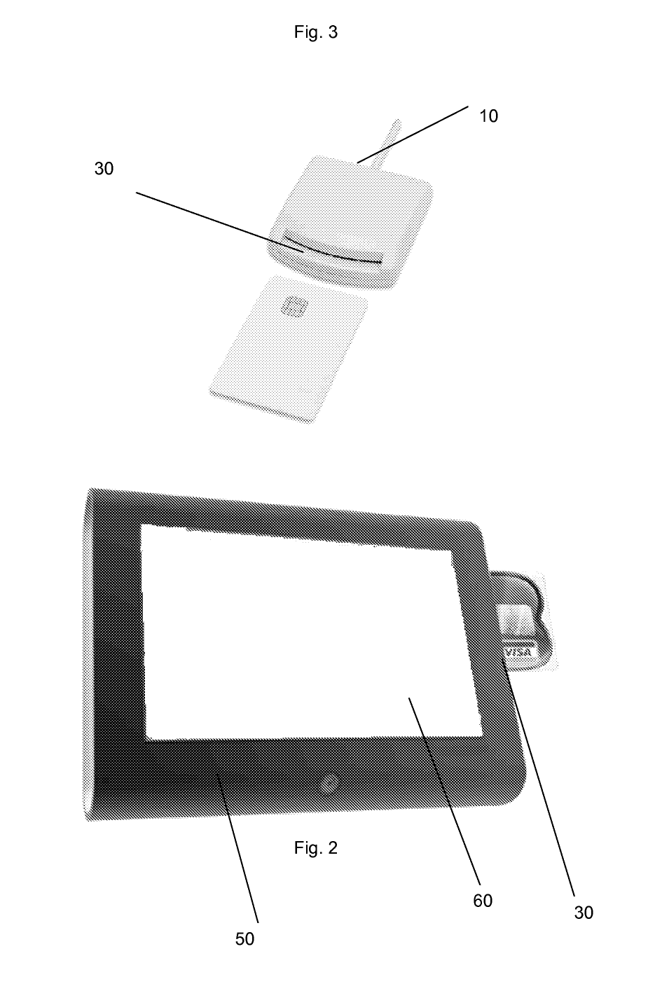

It will be appreciated that the electronic payment unit 10 may be integrated within a device that provides the ability to complete an electronic transaction from browsing to payment. For example, a preferred embodiment of the present invention is illustrated in FIG. 2 in which the electronic payment unit 10 is integrated within the body of a tablet computing device 50. A user is able to browse online stores or services via a web browser or other applications using a user interface 60 (for example touch screen and/or keyboard) of the tablet 50 and upon desiring to make a purchase can insert his or her credit card into a card reader 30. Authentication (such as entry of the card's pin number for a chip and pin card) is performed using the user interface 60 and the electronic payment request transmitted from the data communications interface 20 (which may be a shared data communications interface for all functions of the tablet 50) indicates card presence and an identifier at which the tablet is registered.

It will be appreciated that in such arrangements, the electronic payment request need not necessarily include information such as credit card number and expiry date as in conventional web based electronic credit card transactions. For example, the request may include a hash or some other (potentially one-time) confirmation on the card that has been authenticated. This is clearly advantageous as interception of the request would not necessarily permit the interceptor to spoof future requests using that data. Current payment card standards require that credit card number and expiry date form part of a payment authentication request. However, it will be appreciated that entry and encryption of this information at the electronic payment unit 10 is much more secure than prior art methods such as entry as numeric data over a web interface that could be monitored or otherwise compromised (even if the session to the website is protected with encryption such as SSL).

Although the card reader above is discussed with reference to the card being inserted (as would be the case for chip and pin type cards), other reading mechanisms are also applicable including swiping of magnetic stripe cards and reading cards via near field reading mechanisms.

FIG. 3 is an illustration of an alternate embodiment of the present invention.

In this embodiment, the electronic payment unit 10 is packaged as a USB connectable peripheral, although it will be appreciated that other data connection types such as Firewire and the like are equally applicable.

In this embodiment, the electronic payment unit 10 is connectable via its USB data communications interface 20 to a computing device. Once connected, the unit 100 offers functionality much in the same manner as the tablet discussed above with reference to FIG. 2. Preferably in such an arrangement, the computing device's processor and user interface (screen, keyboard etc.) are utilised by the electronic payment unit during card authentication and generation of the payment request. Similarly, the computing device's data communication connection is used for communicating the payment request for fulfillment. The unit may include a processor and/or memory for performing functions such as encryption and processing of card transactions. In addition, a driver or other computer program executable by the connected computer for accessing and utilising the electronic payment unit 10 may be stored in a memory accessible to the computer once connected. In such an arrangement, memory holding the identifier is preferably segregated (preferably by being stored in physically separated memory) from memory encoding a driver or other computer program such that the identifier can only be accessed through a secure mechanism.

Registration of the electronic payment unit 10 to a location prior to use in making electronic payments is a pre-requisite. One of any number of mechanisms may be used to register the unit 10 to a location. In one example, a device having a fixed location and predetermined identifier may offer registration capabilities.

For example, the device may be a utility meter which includes a unique identifier in the form of a digital certificate and/or an MPAN (Meter Point Administration Number) or another unique identifier. In such an arrangement, the electronic payment unit 10 is connected to the utility meter (typically by a wireless connection (preferably of limited range) such as Zigbee or WiFi but it could be via a wired connection) and a digital certificate or other digital identifier is derived or otherwise downloaded from the utility meter. For example, a digital certificate held by the utility meter may be adapted during registration of the payment unit 10 based on an identifier for the electronic payment unit to produce a unique “fingerprint” that bears the identity of the payment unit 10 which is (or includes) a link to the location of registration. Preferably, the fingerprint would not be reproduced by another device-meter combination.

It will be appreciated that there are many ways of uniquely identifying a place of registration that may additionally or alternatively be taken into account during fingerprint generation. For example, GPS signal references may be used or incorporated into the unique identifier/fingerprint.

In an alternate arrangement, one or more locator nodes that are installable at a location may be used in the registration process to register a payment unit to a location. Each locator node has an identifier and a communication system and is arranged to provide said identifier on demand via said communication system.

For example, as illustrated in FIG. 4, the locator nodes 200 may each be included within a ZigBee enabled plug in electricity meter module. Such electricity meter modules are typically electricity plug adapters that have electrical connectors to be plugged into an electricity socket and a receptacle to receive a plug from a device or appliance to be metered. The modules are configured to allow electricity to pass through the connectors to the appliance or device plugged into the receptacle and passively monitor electricity as it is consumed by the appliance or device. In this embodiment, the modules each include a ZigBee component that provides local wireless communication functionality and a memory in which the identifier is stored and/or encoded.

Optionally, the module may include some form of cryptographic or certification component. It will be appreciated that a communication component other than ZigBee could be used (for example the communication component may be a low power wireless personal area network node such as a 6LoWPAN (see www.6lowpan.org), a powerline node or some other communications node type. Similarly, the locator node could be installable in a telephone network termination unit, within or part of an electricity socket, within or part of a radiator valve or some other fixture within the location. In one embodiment, a plurality of locator nodes may be installed in a variety of fixtures, sockets or devices at a location.

It will furthermore be appreciated that while a plurality of locator nodes are preferred at a location in order to establish an authentication code, this is not essential and a sole locator node could be used.

In the embodiment of FIG. 4, a plurality of plug-in electricity meter modules 200 are installed at the location (in this embodiment a house, office or other building). In operation, a central control node 210 communicates with the ZigBee component of each of the plurality of plug-in electricity meter modules to obtain the identifiers from the respective memories.

The identifiers are then used by the central control node 210 to generate the registration location identifier/fingerprint. This is then recorded as the identifier written to the memory of the payment unit 10 (or else is part of is used to derive the identifier/certificate that is recorded) to authenticate the origin of the unit.

As an added security measure, the electronic payment unit may also include a mechanism by which credit/debit cards must be pre-registered in order to be used. For example, while in communication with the device or system that registers the payment unit, cards can be inserted into the unit and data from those cards is captured and stored in the memory of the payment unit. In one embodiment, only cards registered in this manner may then be used with the payment unit. Such an arrangement would safeguard the payment unit being used to authenticate other cards. Alternatively, some card registration procedure may be included within the payment unit itself and allow card registration subject to provision of appropriate passcodes or the like.

The certificates/identifiers/fingerprints discussed above could be some form of digital cryptographic (such as PKI based) certificate.

In one embodiment, the unique identifier is stored at a remote database which links a physical address of the location of registration to the unique identifier. In this manner, origin of registration can be identified with reference to the database and, should origin be challenged, the location/network address of the control node can be determined so as to communicate the challenge request.

The electronic payment unit 10 may provide support for multiple levels of geo-location assurance, dependent upon the operational and physical environment available at the time of processing a payment transaction.

For example, the electronic payment unit may include a status identifier in a field such as a header entry of the transmitted transaction data (the payment authentication request) that designates geo-location assurance. For example, the field may designate:

Geo-location Guaranteed: The unit is cryptographically bound to a location via a fixed entity such as a smart utility meter, is in real time communication with the meter, and the installation address of the meter has been previously verified;

Time Lapsed Guarantee: The unit is cryptographically bound to a location via a fixed entity such as a smart utility meter, the meter installation address has previously been verified, and (optionally) communication with the smart meter has occurred within a specified timeframe (for example, the binding may be valid only for a number of hours or days after which the indicator may be absent from the header field or may be indicated to have lapsed; alternatively, the authentication request may include data on the time/date of last communication from which the payment authority can decide how to proceed).

The content of GB 1008567.8 and GB 1101789.4 from which this application claims priority and from the abstract which is being filed herewith are hereby incorporated by reference.

1. An electronic payment unit comprising a data communications interface, a payment card reader and a memory,
wherein, during a registration process between the electronic payment unit and a registering system at a location having a unique identifier associated with the location, the electronic payment unit is operative to store the unique identifier, or data derived from or including the unique identifier, in the memory, and
wherein the payment card reader is arranged to read a payment card during an electronic transaction, and to form for transmission, via the data communications interface, an electronic payment request including data on the payment card and on the content of the memory.

2. The electronic payment unit of claim 1, further comprising a payment card registration module arranged to register a payment card for subsequent use with the electronic payment unit, wherein the payment card reader is arranged to form an electronic payment request only for a registered card.

3. The electronic payment unit of claim 2, wherein the payment card registration module is operable only when the electronic payment unit is in communication with the registering system at the location.

4. The electronic payment unit of claim 2, wherein the payment card registration module is operable only during the registration process.

5. The electronic payment unit of claim 1, wherein the data communications interface comprises a data connector for connecting the electronic payment unit to a computer.

6. The electronic payment unit of claim 5, wherein the data connector comprises a universal serial bus, USB, connector.

7. The electronic payment unit of claim 5, further comprising a further memory encoding a driver executable by a computer connected via the data connector for accessing the electronic payment unit.

8. The electronic payment unit of claim 7, wherein the further memory is segregated from the memory for storing the data derived from or including the unique identifier.

9. The electronic payment unit of claim 1, further comprising a geolocation module, the geolocation module being arranged to provide data on its location, the electronic payment unit being arranged to include a status identifier in an electronic payment request, the status identifier designating geo-location assurance.

10. The electronic payment unit of claim 9, wherein the geo-location assurance includes a guaranteed geo-location assurance state in which the unique identifier is cryptographically bound to a location in which the registering system is fixed and, said registering system having been previously verified as being at the location and wherein the electronic payment unit is in substantially real-time communication with the registering system.

11. The electronic payment unit of claim 9, wherein the geo-location assurance includes a time lapsed guaranteed geo-location assurance state in which the unique identifier is cryptographically bound to a location in which the registering system is fixed and in which communication between the electronic payment unit communicated with the registering system at the location within a predetermined time frame.

12. A portable computing device comprising:
an electronic payment unit including a data communications interface, a payment card reader and a memory,
wherein during a registration process between the electronic payment unit and a registering system at a location having a unique identifier associated with the location, the electronic payment unit is operative to store the unique identifier, or data derived from or including the unique identifier in the memory,
wherein the payment card reader is arranged to read a payment card during an electronic transaction, and to form for transmission, via the data communications interface, an electronic payment request including data on the payment card and on the content of the memory,
and wherein the data communications interface comprises a data communications interface of the portable computing device.

13. The portable computing device of claim 12 comprising a tablet computing device having a touch screen arranged to receive user inputs, the electronic payment unit being arranged to output a request for approval of the electronic transaction from a user via the touch screen and receive said approval from the user via inputs via the touch screen, the electronic payment request being formed only upon receipt of said approval.

14. The portable computing device of claim 13, wherein the payment card has an associated authentication code, wherein said approval includes inputting at least a part of said authentication code or data derived from said code via the touch screen.

15. An electronic payment origin authentication system comprising a registration device fixed at a location and having a unique identifier, the registration device including a processor and a data communication interface, the processor being operable to receive a registration request via the data communication interface from an electronic payment unit at the location and is operable to provide registration data to the electronic payment unit in dependence on the unique identifier, the registration data authenticating that the electronic payment unit was present at the location at the time of registration.

16. The electronic payment origin authentication system of claim 15, wherein the registration device comprises a utility meter.

17. (canceled)

18. The electronic payment origin authentication system of claim 15, further comprising a database cross-referencing said registration data with data on the respective location.

19. The electronic payment origin authentication system of claim 15, wherein the registration data comprises a digital certificate determined in dependence on data held by the registration device the digital certificate being uniquely associated with the electronic payment unit.

20. (canceled)

21. The electronic payment origin authentication system claim 15, wherein the registration data includes a validity period, the registration data being valid only until expiry of said validity period.

22. The electronic payment origin authentication system claim 15, including a geolocation system, the geolocation system being arranged to provide geolocation data on the location, the registration data being generated in dependence on the geolocation data.

23. (canceled)

24. (canceled)
